(19) United States
(12) Patent Application Publication
(10) Pub. No.: US 2016/0274887 A1
(43) Pub. Date: Sep. 22, 2016

(54) MODIFYING CLIENT DEVICE GAME APPLICATIONS

(71) Applicant: Zynga Inc., San Francisco, CA (US)

(72) Inventors: Daniel Ian Sternfeld, San Francisco, CA (US); Katherine Lee, San Francisco, CA (US); Sora Bai, San Francisco, CA (US); David Baack, Daly City, CA (US); William Wai Nang Yip, Toronto (CA); Rajesh Patel, Maple (CA)

(21) Appl. No.: 14/662,704

(22) Filed: Mar. 19, 2015

(51) Int. Cl. G06F 9/445; A63F 13/95; A63F 13/22; G06F 9/44; H04L 29/08

(52) U.S. Cl. CPC G06F 8/65; G06F 8/30; H04L 67/34; A63F 13/22; A63F 13/95

(57) ABSTRACT

Techniques for modify a game application without a user request are described herein. A tool chain module can receive, from a first development tool, a first modification code defining a first game modification of a game application on a client device of a user. Additionally, the tool chain module can receive, from a second development tool, a second modification code defining a second game modification of the game application. Furthermore, in an automated operation using one or more computer processors configured to perform the automated operation, the tool chain module can generate a composite modification file based on the first modification code and the second modification code. Subsequently, the tool chain module can transmit the composite modification file to the client device, to enable updating, without a user request from an application store, of the game application on the client device by use of the composite modification file.

### TECHNICAL FIELD

The present disclosure generally relates to games and applications in general and, in particular embodiments, techniques for automatically updating games and applications.

### BACKGROUND

In many game applications, a game developer may need to use several development tools to modify an online game application. For example, a portion of the modification has to be implemented with one development tool (e.g., graphic editor) while another portion of the modification may need another development tool (e.g., animation systems).

Additionally, on the client-side, once the game application is updated by a game developer, the game user often has to manually update the game application in order to use the current version of the application. For example, updating a game application using a mobile device can include downloading a newer version from an application store and installing the newer version on the mobile device.

Furthermore, with current implementations, collaboration between game designers tends to be cumbersome and time consuming. For example, a game designer sometimes has to go through the process of using a number of different development tools to update the game application for making a single modification. Therefore, game developers tend to update the live game application only after enough changes have been made in order to justify the time and effort associated with updating the game application. Such update delays can exacerbate collaboration issues, such as avoiding parallel modifications by different game developers, which can be problematic when multiple game developers are simultaneously working on modifications to a common game application.

### BRIEF DESCRIPTION OF THE DRAWINGS

FIG. 1 is a schematic diagram showing an example of a system, according to some example embodiments.

FIG. 2 is a block diagram illustrating components of a tool chain module, according to some example embodiments.

FIG. 3 illustrates an exemplary block diagram of components for designing a game level using current implementations.

FIG. 4 illustrates a block diagram of components for designing a game level using the tool chain module 201, according to some embodiments.

FIG. 5 is a flowchart showing an example technique for seamlessly updating a game application, according to some example embodiments.

FIG. 6 is a diagrammatic representation of an example data flow between example components of the system of FIG. 1, according to some example embodiments.

FIG. 7 illustrates an example computing system architecture, according to some example embodiments.

### DETAILED DESCRIPTION

A system, a machine-readable storage medium storing instructions, and a computer-implemented method are described herein to seamlessly implement modification within a game application. In the following description, for purposes of explanation, numerous specific details are set forth in order to provide a thorough understanding of example embodiments. It will be evident, however, to one skilled in the art, that the present technology may be practiced without these specific details.

According to various embodiments, a tool chain module can assist a game developer to seamlessly modify items in a game application. Modifiable items in a game application can include, but are not limited to, a game level, an in-game art object, an in-game animation, an in-game virtual object. Examples of game modifications can include level generation and modification, art asset generation and modification (e.g., pixel pushing), and animation generation and modification.

In many current implementations, each modification involves interaction with separate development tools (e.g., graphics editor, animation software, etc.). As a result, the game designer implements a portion of the modification with one development tool while another portion of the modification is implemented with another development tool. Given that each development tool generates an output format unique to that development tool, an output format from a first development tool may have to be converted into a standard format before being inputted into a second development tool. Additionally, after the modification is complete using the various development tools, the output from the last development tool may then have to be converted to binary code. Moreover, the binary code can then converted to distribution code that is specific to various operating systems of the receiving client device. The distribution code is generated based on particular distribution protocols for various mobile devices.

As a result of the utilization of the different development tools, the conversion of the different development tool output formats, the conversion to the binary code, and the conversion to the distribution code, substantial overhead and redundancy is created for updating a game application. Especially when only a minor game modification is being made, such as rendering or changing one virtual object (e.g., art asset). Therefore, with current implementations, the amount of time to implement a modification can take about an hour to a day, depending on the complexity.

In contrast, by use of the tool chain module, the modification can be implemented almost instantaneously. For example, when an animation needs to be further modified based on testing, the animator can simply update the animation within an extension of the tool chain module and push the updated animation to the game application within seconds. By allowing an extension of the tool chain module to push out content into a format useable (e.g., text representation of attributes associated with the game modification) by the game application, the tool chain module can bypass intermediary steps that would otherwise have been necessary.

According to various embodiments, the tool chain module can reduce the time and effort for modifying a game application. For example, when a game modification is made, the tool chain module can receive modification information (e.g., modification code, modification file) from a plurality of development tools. The modification information can be different formats associated with each development tool. The tool chain module is able to recognize and interpret the output format for each development tool, and merge the plurality of received outputs from the development tools into a composite modification file that can represent the game modification in its entirety.

In some instances, the tool chain module can present a user interface that incorporates the plurality of development tools. The tool chain module can include a software extension that allows a game designer to modify any aspect of the game application. Therefore, the game developer can utilize the different development tools within a single user interface to generate the game modification in its entirety. In contrast, with current implementations, the game developer may have to switch between different development tools, each development tool having its own user interface, in order to generate the game modification. By presenting a single user interface, the tool chain module can facilitate a game designer to easily make edits directly into the game application.

The output of the tool chain module can be a composite modification file (e.g., single modification file). The composite modification file can include attributes associated with the game modifications. The attribute can be a data object that is stored or embodied in the modification file. The data object may take many forms, including: text (e.g., ASCII, SGML, and HTML), images, graphics (vector-based or bitmap), audio, video, or other multimedia, and combinations thereof. The data object may also include executable code objects (e.g., games executable within a browser window or frame).

The output of the tool chain module can be a composite modification file. After generating the composite modification file, the composite modification file can be pushed (e.g., uploaded) onto the game networking system. For example, the composite modification file can include text representations of attributes associated with the game modification. Additionally, the modification file can be automatically encapsulated with binary code or distribution code in order for the game application on the client device to automatically receive the information. The encapsulation allows for a seamless transmission of the composite modification file without a game developer requesting a conversion of the file.

Furthermore, the modification file can be transmitted to the client device. In some instances, a client device may already have the game application installed. The game application can include software to decapsulate the information received from the tool chain module. Decapsulation can include removing the binary code or distribution code to obtain the text representations of attributes associated with the game modification. Once the information received is decapsulated, the client device can read the composite modification file and process the modifications to update the game application. Additionally, the game networking system can push the modification to the client device and update the game without requiring the client device to re-install a new version of the whole game.

According to various embodiments, the tool chain module can generate a modification file (e.g., composite modification file) based on a received development tool output format from a first user and another received development tool output format from a second user. By receiving inputs from a plurality of users, the tool chain module can allow different users to work on a portion of a game modification independently.

It is understood that various embodiments include the generation of one or more modules that comprise source code that, when compiled by a computing device(s), creates object code that causes the computing device(s) to perform one or more operations described herein. In other embodiments, any of the modules comprise object code that causes the computing device(s) to perform various operations described herein.

Other embodiments include the generation of one or more modules that comprise source code that, when compiled by a client computing device(s), creates object code that causes the client computing device(s) to perform one or more operations described herein in communication with a server computing devices(s). In other embodiments, any of the modules comprise object code that causes the client computing device(s) to perform various operations described herein in communication with the server computing devices(s).

Other embodiments include the generation of one or more modules that comprise source code that, when compiled by a server computing device(s), creates object code that causes the server computing device(s) to perform one or more operations described herein in communication with one or more client computing devices. In other embodiments, any of the modules comprise object code that causes the server computing device(s) to perform various operations described herein in communication with the one or more client computing devices.

### Social Network Systems and Game Networking Systems

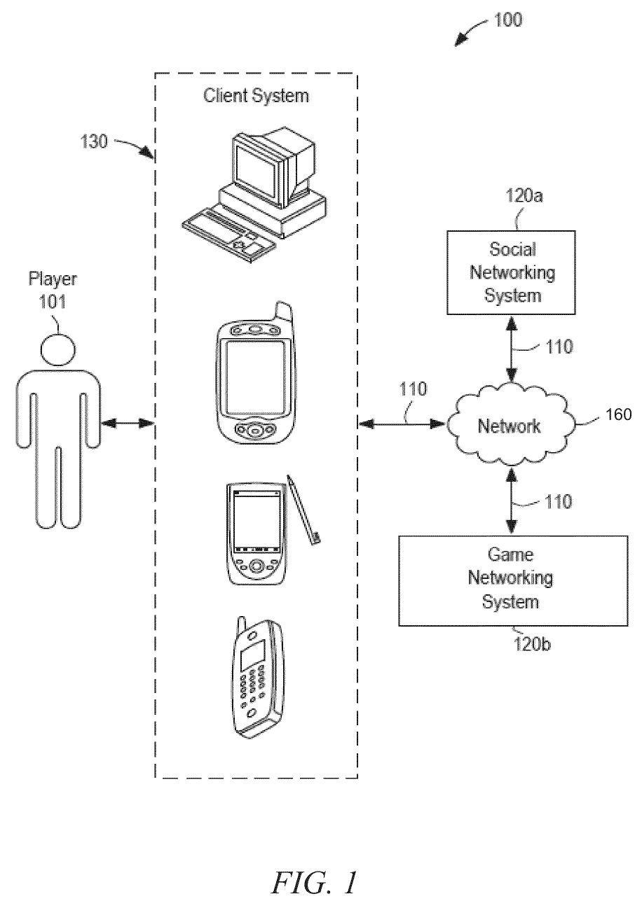

FIG. 1 illustrates an example of a system for implementing various disclosed embodiments. In particular embodiments, system 100 comprises player 101, social networking system 120a, game networking system 120b (i.e. online gaming system), client system 130, and network 160. The components of system 100 can be connected to each other in any suitable configuration, using any suitable type of connection. The components may be connected directly or over a network 160, which may be any suitable network. For example, one or more portions of network 160 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, another type of network, or a combination of two or more such networks.

Social networking system 120a (i.e. social network system) is a network-addressable computing system that can host one or more social graphs. Social networking system 120a can generate, store, receive, and transmit social networking data. Social networking system 120a can be accessed by the other components of system 100 either directly or via network 160. Game networking system 120b is a network-addressable computing system that can host one or more online games. Game networking system 120b can generate, store, receive, and transmit game-related data, such as, for example, game account data, game input, game state data, and game displays. Game networking system 120b can be accessed by the other components of system 100 either directly or via network 160. Player 101 may use client system 130 to access, send data to, and receive data from social networking system 120a and game networking system 120b. Client system 130 can access social networking system 120a or game networking system 120b directly, via network 160, or via a third-party system. As an example, and not by way of limitation, client system 130 may access game networking system 120b via social networking system 120a. Client system 130 can be any suitable computing device, such as a personal computer, laptop, cellular phone, smart phone, computing tablet, etc.

Although FIG. 1 illustrates a particular number of players 101, social network systems 120a, game networking systems 120b, client systems 130, and networks 160, this disclosure contemplates any suitable number of players 101, social network systems 120a, game networking systems 120b, client systems 130, and networks 160. As an example and not by way of limitation, system 100 may include one or more game networking systems 120b and no social networking systems 120a. As another example and not by way of limitation, system 100 may include a system that comprises both social networking system 120a and game networking system 120b. Moreover, although FIG. 1 illustrates a particular arrangement of player 101, social networking system 120a, game networking system 120b, client system 130, and network 160, this disclosure contemplates any suitable arrangement of player 101, social networking system 120a, game networking system 120b, client system 130, and network 160.

The components of system 100 may be connected to each other using any suitable connections 110. For example, suitable connections 110 include wireline (such as, for example, digital subscriber line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) connections. In particular embodiments, one or more connections 110 each include an ad hoc network, an intranet, an extranet, a VPN, a LAN, a WLAN, a WAN, a WWAN, a MAN, a portion of the Internet, a portion of the PSTN, a cellular telephone network, or another type of connection, or a combination of two or more such connections. Connections 110 need not necessarily be the same throughout system 100. One or more first connections 110 may differ in one or more respects from one or more second connections 110. Although FIG. 1 illustrates particular connections 110 between player 101, social networking system 120a, game networking system 120b, client system 130, and network 160, this disclosure contemplates any suitable connections 110 between player 101, social networking system 120a, game networking system 120b, client system 130, and network 160. As an example, and not by way of limitation, in particular embodiments, client system 130 may have a direct connection to social networking system 120a or game networking system 120b, bypassing network 160.

### Online Games and Game Systems

Game Networking Systems

In an online computer game, a game engine manages the game state of the game. Game state comprises all game play parameters, including player character state, non-player character (NPC) state, in-game object state, game world state (e.g., internal game clocks, game environment), and other game play parameters. Each player 101 controls one or more player characters (PCs). The game engine controls all other aspects of the game, including non-player characters (NPCs), and in-game objects. The game engine also manages game state, including player character state for currently active (online) and inactive (offline) players 101.

An online game can be hosted by game networking system 120b (i.e. online gaming system), which includes a notification generator that performs operations according to embodiments as described herein. The game networking system 120b can be accessed using any suitable connection with a suitable client system 130. A player 101 may have a game account on game networking system 120b, wherein the game account can contain a variety of information associated with the player 101 (e.g., the player 101's personal information, financial information, purchase history, player character state, game state). In some embodiments, a player 101 may play multiple games on game networking system 120b, which may maintain a single game account for the player 101 with respect to all the games, or multiple individual game accounts for each game with respect to the player 101. In some embodiments, game networking system 120b can assign a unique identifier to each player 101 of an online game hosted on game networking system 120b. Game networking system 120b can determine that a player 101 is accessing the online game by reading the user's cookies, which may be appended to HTTP requests transmitted by client system 130, and/or by the player 101 logging onto the online game.

In particular embodiments, player 101 may access an online game and control the game's progress via client system 130 (e.g., by inputting commands to the game at the client device). Client system 130 can display the game interface, receive inputs from player 101, transmitting user inputs or other events to the game engine, and receive instructions from the game engine. The game engine can be executed on any suitable system (such as, for example, client system 130, social networking system 120a, or game networking system 120b). As an example, and not by way of limitation, client system 130 can download client components of an online game, which are executed locally, while a remote game networking system, such as game networking system 120b, provides backend support for the client components and may be responsible for maintaining application data of the game, processing the inputs from the player 101, updating and/or synchronizing the game state based on the game logic and each input from the player 101, and transmitting instructions to client system 130. As another example, and not by way of limitation, each time player 101 provides an input to the game through the client system 130 (such as, for example, by typing on the keyboard or clicking the mouse of client system 130), the client components of the game may transmit the player 101's input to game networking system 120b.

### Storing Game-Related Data

A database may store any data relating to game play within a game networking system 120b. The database may include database tables for storing a player game state that may include information about the player 101's virtual gameboard, the player 101's character, or other game-related information. For example, player game state may include virtual objects owned or used by the player 101, placement positions for virtual structural objects in the player 101's virtual gameboard, and the like. Player game state may also include in-game obstacles or tasks for the player 101 (e.g., new obstacles, current obstacles, completed obstacles, etc.), the player 101's character attributes (e.g., character health, character energy, amount of coins, amount of cash or virtual currency, etc.), and the like.

The database may also include database tables for storing a player profile that may include user-provided player information that is gathered from the player 101, the player 101's client device, or an affiliate social network. The user-provided player information may include the player 101's demographic information, the player 101's location information (e.g., a historical record of the player 101's location during game play as determined via a GPS-enabled device or the internet protocol (IP) address for the player 101's client device), the player 101's localization information (e.g., a list of languages chosen by the player 101), the types of games played by the player 101, and the like.

### Game Systems, Social Networks, and Social Graphs:

In an online multiplayer game, players 101 may control player characters (PCs), a game engine controls non-player characters (NPCs) and game features, and the game engine also manages player character state and game state and tracks the state for currently active (i.e., online) players 101 and currently inactive (i.e., offline) players 101. A player character can have a set of attributes and a set of friends associated with the player character. As used herein, the term “player character state” can refer to any in-game characteristic of a player character, such as location, assets, levels, condition, health, status, inventory, skill set, name, orientation, affiliation, specialty, and so on. Player characters may be displayed as graphical avatars within a user interface of the game. In other implementations, no avatar or other graphical representation of the player character is displayed. Game state encompasses the notion of player character state and refers to any parameter value that characterizes the state of an in-game element, such as a non-player character, a virtual object (such as a wall or castle), etc. The game engine may use player character state to determine the outcome of game events, sometimes also considering set or random variables. Generally, a player character's probability of having a more favorable outcome is greater when the player character has a better state. For example, a healthier player character is less likely to die in a particular encounter relative to a weaker player character or non-player character. In some embodiments, the game engine can assign a unique client identifier to each player 101.

In particular embodiments, player 101 may access particular game instances of an online game. A game instance is copy of a specific game play area that is created during runtime. In particular embodiments, a game instance is a discrete game play area where one or more players 101 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables. A game instance may be exclusive (i.e., accessible by specific players 101) or non-exclusive (i.e., accessible by any player 101). In particular embodiments, a game instance is populated by one or more player characters controlled by one or more players 101 and one or more in-game objects controlled by the game engine. When accessing an online game, the game engine may allow player 101 to select a particular game instance to play from a plurality of game instances. Alternatively, the game engine may automatically select the game instance that player 101 will access. In particular embodiments, an online game comprises only one game instance that all players 101 of the online game can access.

In particular embodiments, a game engine can interface with a social graph. Social graphs are models of connections between entities (e.g., individuals, users, contacts, friends, players 101, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In particular embodiments, a unique client identifier can be assigned to each user in the social graph. This disclosure assumes that at least one entity of a social graph is a player 101 or player character in an online multiplayer game, though this disclosure may apply to any suitable social graph users.

The minimum number of edges needed to connect a player 101 (or player character) to another user is considered the degree of separation between them. For example, where the player 101 and the user are directly connected (one edge), they are deemed to be separated by one degree of separation. The user would be a so-called “first-degree friend” of the player 101. Where the player 101 and the user are connected through one other user (two edges), they are deemed to be separated by two degrees of separation. This user would be a so-called “second-degree friend” of the player 101. Where the player 101 and the user are connected through N edges (or N−1 other users), they are deemed to be separated by N degrees of separation. This user would be a so-called “Nth-degree friend.” As used herein, the term “friend” means only first-degree friends, unless context suggests otherwise.

Within the social graph, each player 101 (or player character) has a social network. A player 101's social network includes all users in the social graph within Nmax degrees of the player 101, where Nmax is the maximum degree of separation allowed by the system managing the social graph (such as, for example, social networking system 120a or game networking system 120b). In one embodiment, Nmax equals 1, such that the player 101's social network includes only first-degree friends. In another embodiment, Nmax is unlimited and the player 101's social network is coextensive with the social graph.

In particular embodiments, the social graph is managed by game networking system 120b, which is managed by the game operator. In other embodiments, the social graph is part of a social networking system 120a managed by a third party (e.g., Facebook, Friendster, Myspace). In yet other embodiments, player 101 has a social network on both game networking system 120b and social networking system 120a, wherein player 101 can have a social network on the game networking system 120b that is a subset, superset, or independent of the player 101's social network on social networking system 120a. In such combined systems, game network system 120b can maintain social graph information with edge type attributes that indicate whether a given friend is an “in-game friend,” an “out-of-game friend,” or both. The various embodiments disclosed herein are operable when the social graph is managed by social networking system 120a, game networking system 120b, or both.

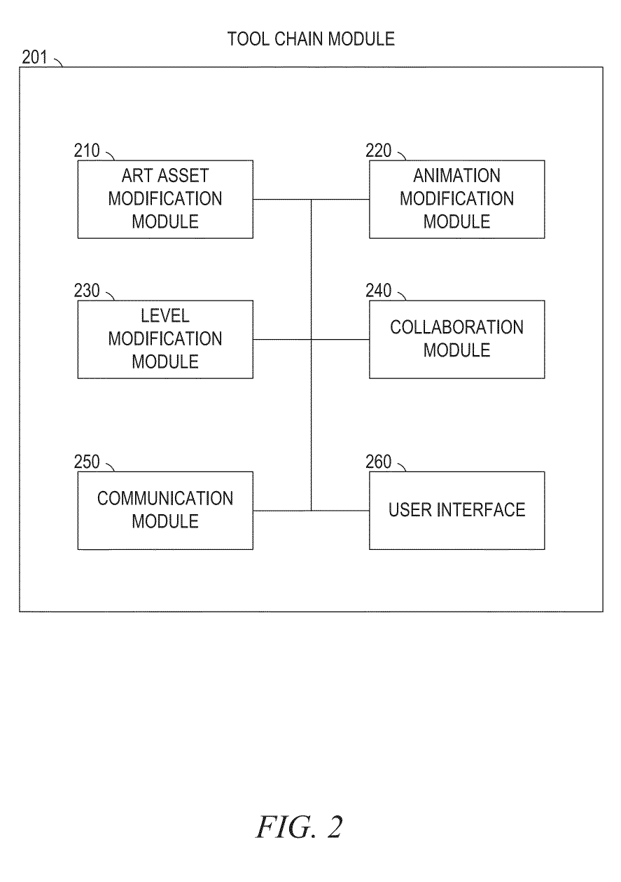

FIG. 2 is a block diagram illustrating components of a tool chain module 201, according to one example embodiment. In some instances, the game network system 120b can include the tool chain module 201. The tool chain module 201 in this example embodiment includes an art asset modification module 210, an animation modification module 220, a level modification module 230, a collaboration module 240, a communication module 250, and user interface 260.

The art asset modification module 210 can allow a game developer to seamlessly update (e.g., modify, generate) art assets in a game application. For example, in current implementations, a game developer (e.g., an artist) may use a native tool, such as a graphics editor, to create an art asset. Modification of an asset can include changes in the background image, the tile image, displayed game parameters, any visual asset in the game, and so on. Then, the asset from the graphics editor can be exported into an integrated development environment, such as Xcode. Additionally, the artist further can modify (e.g., color correction, batch resizing of photo) the asset using the integrated development environment. Then the output of the integrated development environment is converted to binary format in order to test the new asset in the game application. Furthermore, when the asset needs to be further modified based on the testing, then the artist starts again with the first step of modifying the asset in the native tool, such as a graphic editor.

In contrast, with the art asset modification module 210, the game developer simply makes the game modification associated with the art asset on the user interface 260. The game modification can be based on a change in an attribute associated with the art asset. The change in attribute can be received from an input from the game developer on the user interface 260. The input can be based on features or edits normally associated with a graphic editor. Once the game modification is complete, the game developer can request to push (e.g., transmit) the game modification to the game application on the client system 130 seamlessly in real-time via network 160. The request can be as simple as selecting the export button on the user interface 260. As a result of the request, the game application on the client system 130 is updated in real-time with the modified art asset without a user input from the player 101.

Similarly, the animation modification module 220 can allow a game developer to make a game modification associated with animation on the user interface 260. For example, the game developer can generate a game modification associated with an animation on the user interface 260. The game modification can be based on a change in an attribute associated with the animation. The change in attribute can be received from an input from the game developer on the user interface 260. The input can be based on features or edits normally associated with animation software. An animation modification can include changes such as how the dialogues fly in, timing of animation, special effects (e.g., fading), and so on. Once the game modification is complete, the game developer can request to push (e.g., transmit) the game modification to the game application on the client system 130 seamlessly in real-time via network 160. As previously mentioned, the request can be as simple as selecting the export button on the user interface 260. As a result of the request, the game application on the client system 130 is updated in real-time with the modified animation without a user input from the player 101.

With regards to current implementation, in an animation modification example, the animator can use a native animation tool to create or modify an animation. Then the output of the animation tool is inputted into the integrated development environment, such as Xcode. The animators can further modify (e.g., change the timing) the animation in the integrated development environment. Then the output of the integrated development environment is converted to binary format. Additionally, when the animation needs to be further modified based on the testing (e.g., the timing of the animation is incorrect), then the animator starts again with of first step of modifying the animation in the native animation tool. As described, current implementations of animation modification can be inefficient, in comparison to the methods described herein using the tool chain module 201.

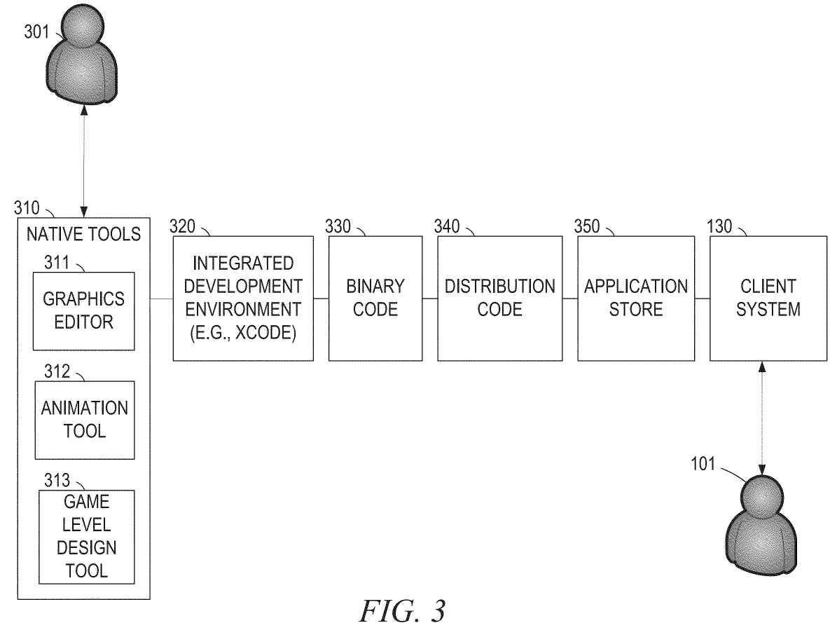

Additionally, the tool chain module 201 improves collaboration between game designers using collaboration module 240. FIG. 3 illustrates block diagram of components for designing a game level using current implementations. Designing a game level includes generating level related information such as a design layout of the game.

To illustrate, in the first step, a game developer 301 (e.g., first level designer) can create a level using native tools 310 to create the level. The native tools can include a graphic editor 311, an animation tool 312, a game level design tool 313, and so on. In some instances, the game developer had to export a first modification file (e.g., created asset from the graphic editor to the animation software. The animation software would be used to add animation to the asset before exporting a second modification file to an integrated development tool 320.

In the second step, the output from the native tools can be exported into an integrated development environment 320. The integrated development environment 320 can contain a suite of software development tools for developing software for a specific operating system. Xcode is an example of the integrated development environment 320 that is developed by Apple® for developing software for Apple's mobile operating system (i.e., iOS). Using the integrated development environment 320, the modification to the game level can be built for the specific operating system.

In the third step, after the game level has been built, the next step is to convert the output of the integrated development environment 320 to binary code 330. The conversion to binary code 330 allows sharing to other level designers. The other level designers can download the binary code 330 to update the game application. Other level designers can now make modifications to a level using the updated game application.

Additionally, in the fourth step, the binary code 330 can be converted to distribution code 340, where the distribution code 340 is dependent on the operating system of the client device. Furthermore, in the fifth step, the distribution code 340 can be transmitted to an application store 350 to be downloaded, by player 101, on a client system 130 in the sixth step.

In contrast, the collaboration module 240 allows collaboration without the arduous process listed above. For example, using the user interface 260 and the level modification module 230, a level designer can visually create a level using an extension of a software development kit (e.g., Unity). The level modification module 230 can access a software development kit which includes a rendering engine integrated with a set of tools and workflows to create interactive three-dimensional (3D) and two-dimensional (2D) content and multiplatform publishing. Continuing with the example, once the level is created, the level designer can export (e.g., push, transmit) the created level to the game application. The export can be as simple as the level designer selecting the export button on the user interface 260 of the software development kit. Once the level is exported, other developers and players 101 can synchronize the game application, which includes the new level. The collaboration module 240 can synchronize the modifications between different developers.

Additionally, the tool chain module 201 allows the modification to be instantaneously reflected in the game application, and the modification is shared to other game designers. Moreover, the newly generated game level can be included in the game application of game users (e.g., player 101) without the need to download the updated version of the game application from the application store. As previously mentioned, using the level modification module 230, a game designer can generate a new level for a game. Then the tool chain module 201 can modify the game application with the new level without having the user download an updated version of the game application from the application store.

In some instances, each level of a game can have a first modification information (e.g., level definition file), which can be modified by the tool chain module 201 and the level modification module 230. The level definition file can have attributes that can be modified by the tool chain module 201 using text representations associated with the attributes. The first modification information can include one or more attributes (e.g., game play parameters, game related data, game instances, player character state, features, or game level settings) that can be modified by the tool chain module 201 in order to customize a player 101's experience.

Furthermore, a first modification information (e.g., first level definition file) can be used by a level definition file module executing on a client computing device to modify a first set of attributes for a first level, and a second modification information (e.g., second level definition file) can be used by the level definition file module to modify a second set of attributes for a second level. Alternatively, the second modification information can be an art asset definition file or an animation file.

It is understood that, in some embodiments, the first modification information and the second modification information indicate different attributes that can be modified by the game developer using the tool chain module 201 using text representations associated with specific attributes (e.g., game play parameters, game related data, game instances, player character state, features, or game level settings). For example, a level definition file can indicate multiple attributes of a game level to be modified. The tool chain module 201 can update a level definition file to be processed by the client system 130. It is understood that such attributes as can be indicated for modification by a level definition file are, but are not limited to, types of game obstacles or hazards, a rate of appearance of various types of game obstacles or hazards, types of game bonus opportunities, a rate of appearance of various types of game opportunities, a range of motion allowed for a player 101, a range of speed allowed for a player 101, a rate of appearance of one or more chances to earn bonuses, respective amounts of rewards and a range of times to accomplish a game goal.

According to various embodiments, the tool chain module 201 can transmit content that can be processed by the game application installed on the client system 130 by formatting the information about the modification into text (e.g., American Standard Code for Information Interchange (ASCII) characters). By having a text representation of attributes associated with the game application, the tool chain module 201 can modify the game application by editing the text representation of the attributes. For example, a level may be associated with text representation of attributes corresponding to specific details about the level, such as the layout, art assets used, starting title, drop rates of additional titles, and so on. The tool chain module 201 can specify all the attributes associated with the level in a text representation.

In some instances, the text representation can be packaged (e.g., encapsulated) by the tool chain module 201 with binary data and transmitted to game networking system 120b or client system 130. The packaged data can then be deciphered by the receiving system, which can be the game networking system 120b, client system 130, or a software extension on the installed game application.

With regards to the software extension on the installed game application, the tool chain module 201 can include an extension for a software development kit (e.g., Unity), where the extension includes a proprietary data format that is consumable by the game application. As a result, the game application can easily be modified by the tool chain module 201 by bypassing the multiple-step process previously described in current implementations.

By using the tool chain module 201, the modifications can be instantly shared with other game developers (e.g., artists, animators, level designers), or game players 101. Using the export function for the tool chain module 201, the modification can be pushed to the game application. Additionally, the game application can be updated with the modification without the player 101 having to download an updated version of the game application from the application store.

Continuing with the collaboration example, the modifications from a plurality of developers can be transmitted to the game networking system 120b, and the client system 130 can retrieve the modifications from the game networking system 120b. The modifications can automatically be retrieved during a synchronization of the game application. The collaboration module 240 helps resolve potential conflicts between similar attributes associated with the game modification.

For example, initially, the game application is downloaded on the client device. Then, during subsequent synchronization, the modifications are automatically retrieved. Synchronization can occur when a game is started, when a level is completed, when a user returns to a game after a paused session, and so on. During the synchronization, the version of the game application installed on the client device is compared against the most current version of the game application on the game networking system 120b. In response to the comparison, if the game application installed on the client device is not the most current version of the game application, then the modifications associated with the most current version are retrieved by the client device from the game networking system 120b. For example, the game application can determine the differences between the versions, and automatically incorporate the new updates.

By automatically retrieving modifications from the game networking system 120b, the game designers do not need to submit a request to application store in order to update the game application. By not having to submit a request to the application store, the process of updating the game application is significantly reduced.

According to various embodiments, the text representations corresponding to a modification can be processed by the client device, which in turn updates the game application stored on the client device. Alternatively, the game networking system 120b can process the text representations corresponding to the modification, and transmit processed data to the client device.

In the instances where the client device processed the text representations corresponding to a modification, the client device can determine the modification based on the retrieved text representation. The client device can have a software extension, custom code, or hardware to handle the output (e.g., text representation) from the tool chain module 201. The custom code or hardware can be implemented by the client device or the game application. The output from the extension of the software development kit is an example of an output from the tool chain module 201.

For example, a game designer can create a new level using the tool chain module 201 and transmit the new level to the game networking system 120b. On the client side, during synchronization, the game application determines that a newer version exists, and therefore automatically updates the game by incorporating the new level. The modifications associated with the game are translated into text representations, which are transmitted to the client device via a retrieval request by the game application.

The synchronization can be controlled by the collaboration module 240 to check for deltas (e.g., differences) between different versions of the game application. In some instances, the collaboration module 240 can be part of the game application installed in the client system 130. By keeping track of the versions and the deltas between the versions, the game application can request specific modifications via a package from the game networking system 120b. Alternatively, the game networking system 120b can push specific modifications via a package to the client device based on a received version number of the game application installed on the client device. The package can include all the modifications that are now incorporated in the newest version of the game in comparison to the version of the game installed on the client device.

The collaboration module 240 can include a state machine. The state machine can keep track of all the modifications that have been incorporated in each incremental update. In some instances, the same art asset can be updated several times between synchronization, but only the most recent version of the art asset is pushed to the client device. As a result of the collaboration module 240, the updates are less time consuming, the data size associated with the package update is smaller, which reduces the network burden, and the processing time is reduced.

For example, with the collaboration module 240, a plurality of game designers can independently change the same art asset. The tool chain module 201 can determine the most up-to-date art asset without requiring the plurality of game designers communicate with each other. The tool chain module 201 can automatically synchronize the game application, so the game designers will have the most up-to-date information without having to manually download a newer version of the game application.

Additionally, the collaboration module 240 includes a conflict resolution feature so that a plurality of modifications can be implemented together. For example, a first game developer can change an art asset (e.g., changing a letter from F to E), and a second game developer can change the background. In this instance, the collaboration module 240 can implement both modifications during synchronization since the modifications do not conflict with each other.

Continuing with the conflict resolution feature for the multiple designer example, the collaboration module 240 can determine and resolve all the modifications for the game application based on an attribute. For example, and attribute for a word game can include, but is not limited to, the number of moves, the starting pattern of tiles, the layout of letters, the objective types, the order of the levels, what tiles drop in, a bonus meter, metering parameters, and so on. When the attributes are different, both modifications can be implemented by the tool chain module 201. Alternatively, when the attributes are the same, then the most recent change is implemented.

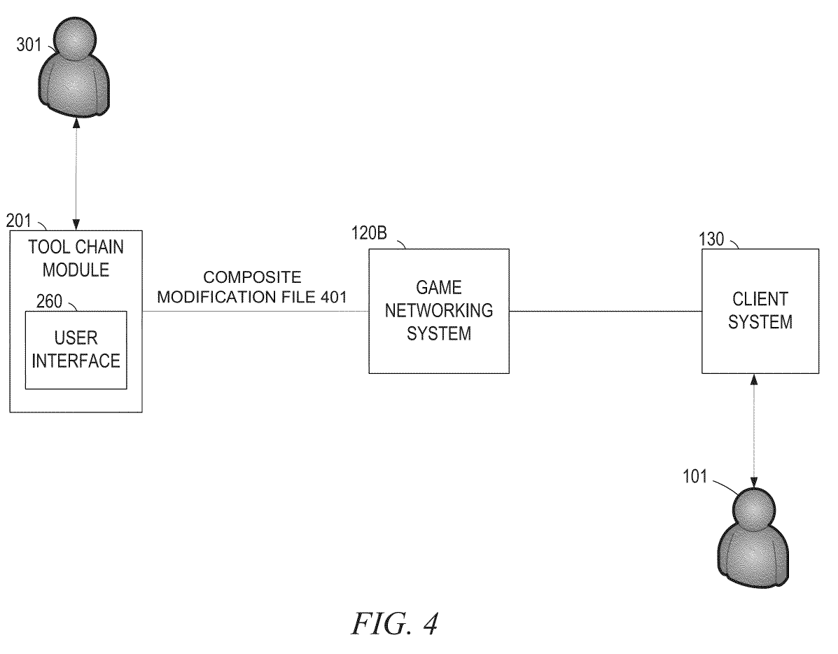

In various example embodiments, the communication module 250 is a hardware-implemented module that controls, manages and stores information related to sending a composite modification file to a client system 130, game networking system 120b, or social networking system 120a. The user interface 260 is a module that can receive user input (e.g., input from a game developer 301) for the tool chain module 201. The user interface is further described in FIG. 4.

The modules 210-260 are configured to communicate with each other (e.g., via a bus, shared memory, or a switch). Any one or more of the modules 210-260 described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

FIG. 4 illustrates a block diagram of components for designing a game level using the tool chain module 201, according to various embodiments. For example, a game developer 301 can create an asset using the user interface 260 of the tool chain module 201. Then, once the asset is created, using the same user interface 260 of the tool chain module 201, the game developer can add animation to the created asset. Subsequently, the animation and the asset are combined and pushed to the game application. The tool chain module 201 presents the game developer a user interface 260 that allows for the visualization of a plurality of different development tools in a single user interface 260. The single interface allows the game developer the ability to adjust the modification in real-time without having to go back-and-forth between different development tools. The tool chain module 201 can merge the output of the plurality of the development tools, and present the merged output in a single interface.

After generating the game modification, the output of the tool chain module 201 can be pushed (e.g., uploaded) onto the game networking system 120b. The output of the tool chain module 201 can be a composite modification file 401. The composite modification file 401 can include text representations of attributes (e.g., game play parameters, game related data, game instances, player character state, features, or game level settings) associated with the game modification. Additionally, the output of the tool chain module 201 can be automatically encapsulated with binary code or distribution code in order for the game application on the client system 130 to automatically receive the information. The game modification (e.g., composite modification file 401) can be received without a request from player 101.

Furthermore, the composite modification file 401 can be transmitted to the client device. In some instances, a client device may already have the game application installed. The game application can include software to decapsulate the information received from the tool chain module 201. Decapsulation can include removing the binary code or distribution code to obtain the text representations of attributes associated with the game modification. Once the information received is decapsulated, the client device can read the composite modification file 401 and process the modifications to update the game application. Additionally, the game networking system 120b can push the modification to the client system 130 and update the game without requiring the client system 130 to re-install a new version of the game.

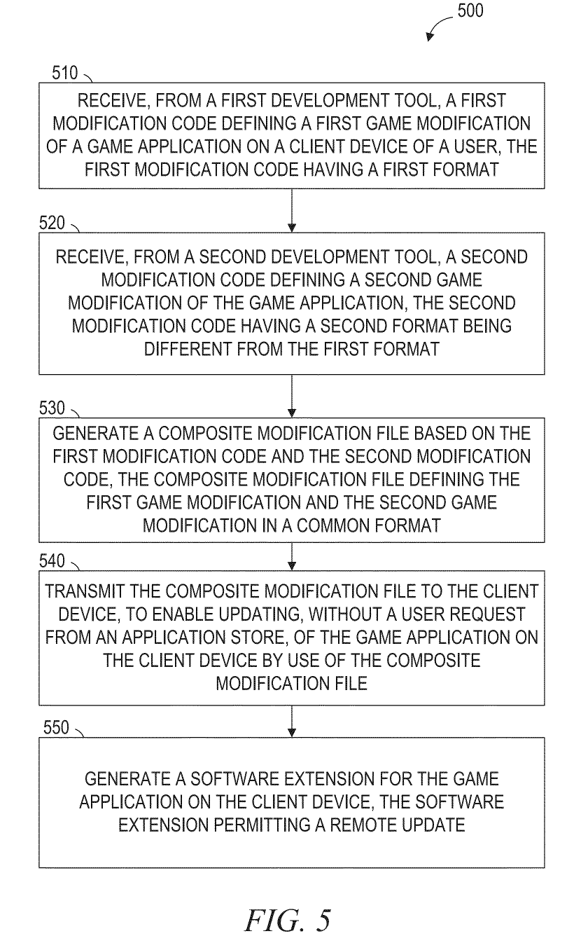

FIG. 5 is a flowchart 500 showing an example method of sending a level definition file and a hardness quotient to a client computing device.

At operation 510, the tool chain module 201 can receive, from a first development tool, a first modification code. The first modification code (e.g., first file) can define a first game modification of a game application on a client device (e.g., client system 130) of a user (e.g., player 101). In some instances, the tool chain module 201 can receive modification information from the first development tool. Additionally, the first modification code can have a first format. The first modification code can have attributes corresponding to the game modification. The first modification code can be received using communication module 250. The first development tool can include a graphic editor, animation software, game level generation software, or another tool used to modify a game application. Depending on the first development tool, the art asset modification module 210, the animation module 220, the level modification module 230, and the collaboration module 240 can take the attributes of the first modification code and automatically convert the attributes in a standard format (e.g., text representation) to be included in the composite modification file 401.

In some instances, the features (e.g., methods of modifying the art asset, methods of modifying the animation, methods of modifying the game level) of the first development tool can be presented on user interface 260, and the received input from a game developer can be an attribute associated with a feature of the first development tool. For example, the game developer can change the letter “E” to an “F” in the word puzzle (e.g., Words on Tour®) game application. In this example, the first development tool is a graphic editor. The graphic editor can have features such as changing a letter, changing a color, and so on. Continuing with this example, the attribute in the first modification code can be the specific letter for a specific tile in the word puzzle. The game developer can change the letter for the specific tile by selecting, on the user interface 260, a feature associated with changing letters for a tile.

At operation 520, the tool chain module 201 can receive, from a second development tool, a second modification code. The second modification code (e.g., second file) can define a second game modification of the game application. The second modification code can have a second format being different from the first format. The second modification code can be received using communication module 250 or user interface 260. Depending on the first development tool, the art asset modification module 210, the animation module 220, the level modification module 230, and the collaboration module 240 can take the attributes of the first modification code and automatically convert the attributes in a standard format (e.g., text representation) to be included in the composite modification file 401.

The second modification code can have attributes corresponding to the same game modification of operation 510, or a different game modification. For example, the first modification code can correspond to an output of a graphic editor tool, while the second modification code can correspond to an output of the animation software. Continuing with the example, in addition to changing the letter on the tile at operation 510, the game developer can use the animation software to add animation to the same tile. Alternatively, in another example, a game developer can use the animation software to modify a current animation (e.g., fading of background) in the word puzzle. With these examples, the animation modification module 220 can receive the second modification code and convert the attributes in a standard format to be included in the composite modification file 401.

At operation 530, the tool chain module 201 can generate a composite modification file 401 based on the first modification code and the second modification code. The composite modification file 401 can define the first game modification and the second game modification in a common format. The composite modification file 401 can include attributes from the first modification code and the second modification code. Using the art asset modification module 210, the animation module 220, the level modification module 230, the attributes of the first modification code and second modification code can be converted into a text representation to be included in the composite modification file 401. Additionally, the collaboration module 240 can resolve conflicts between the first modification code and the second modification code. As previously mentioned, the collaboration module 240 can have a state machine for each attribute, and only include the most current version of the attribute based on the state machine.

At operation 540, the tool chain module 201 can transmit the composite modification file 401 to the client device (e.g., client system 130). The tool chain module 201 can use the composite modification file 401 to update the game application on the client system 130. Updating of the game application on the client device can be enabled by use of the composite modification file 401. The updating can be enabled without a user request from an application store 350. In some instances, the game application can be updated without a user request to download a newer version of the game application from the application store. For example, the game application can be pushed to the game application on the client device directly from the game networking system 120b. The composite modification file 401 can be uploaded into the game networking system 120b by a game developer.

At operation 550, the tool chain module 201 can generate a software extension for the game application. The software extension can be installed on the client device. In some instances, the software extension is installed when the player 101 requests a newer version of the game application from the application store. Using the software extension, the tool chain module 201, or the game networking system 120b can remotely update the game application installed on the client device without having the player 101 manually request an update.

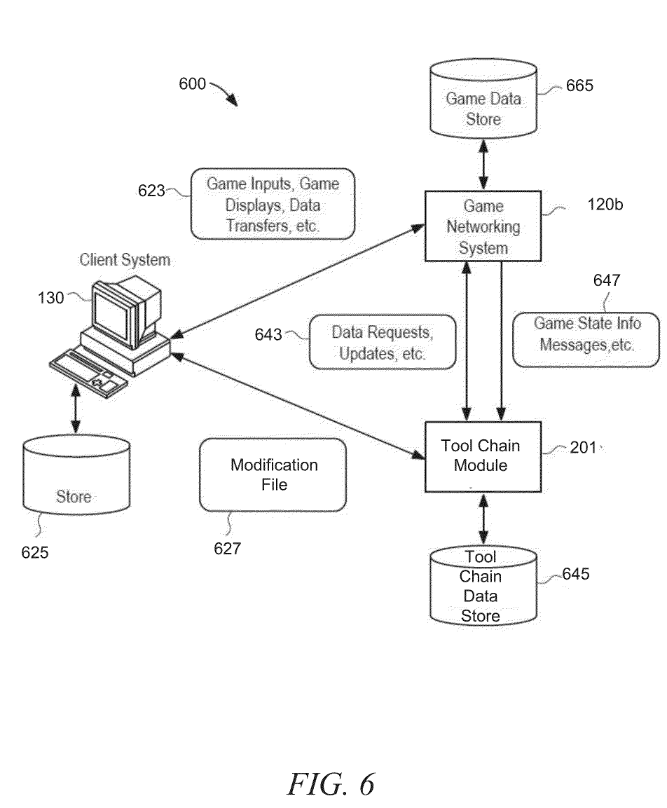

FIG. 6 illustrates an example data flow between the components of system 600. In particular embodiments, system 600 can include client system 130, tool chain module 201, and game networking system 120b (i.e. online game system). The components of system 600 can be connected to each other in any suitable configuration, using any suitable type of connection. The components may be connected directly or over any suitable network 160. Client system 130, tool chain module 201, and game networking system 120b can each have one or more corresponding data stores such as local data store 625, tool chain data store 645, and game data store 665, respectively. Tool chain module 201 and game networking system 120b can also have one or more servers that can communicate with client system 130 over an appropriate network 160. Tool chain module 201 and game networking system 120b can have, for example, one or more internet servers for communicating with client system 130 via the Internet. Similarly, tool chain module 201 and game networking system 120b can have one or more mobile servers for communicating with client system 130 via a mobile network (e.g., GSM, PCS, Wi-Fi, WPAN, etc.). In some embodiments, one server may be able to communicate with client system 130 over both the Internet and a mobile network. In other embodiments, separate servers can be used.

Client system 130 can receive and transmit data 623 to and from game networking system 120b. This data can include, for example, webpages, messages, game inputs, game displays, HTTP packets, data requests, transaction information, updates, and other suitable data. At some other time, or at the same time, game networking system 120b can communicate data 643, 647 (e.g., game state information, game system account information, page info, messages, data requests, updates, etc.) with other networking systems, such as tool chain module 201. Client system 130 can also receive and transmit modification file 627 (e.g., composite modification file 601 from operation 530) to and from tool chain module 201. This data can include, for example, attributes associated with a game modification for the game application.

Communication between client system 130, tool chain module 201, and game networking system 120b can occur over any appropriate electronic communication medium or network 160 using any suitable communications protocols. For example, client system 130, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end-systems described herein may use a variety of higher layer communications protocols, including client-server (or request-response) protocols, such as the HyperText Transfer Protocol (HTTP) and other communications protocols, such as HTTPS, FTP, SNMP, TELNET, and a number of other protocols, may be used. In some embodiments, no protocol may be used and, instead, transfer of raw data may be utilized via TCP or User Datagram Protocol. In addition, a server in one interaction context may be a client in another interaction context. In particular embodiments, the information transmitted between hosts may be formatted as HyperText Markup Language (HTML) documents. Other structured document languages or formats can be used, such as XML, and the like. Executable code objects, such as JavaScript and ActionScript, can also be embedded in the structured documents.

In some client-server protocols, such as the use of HTML over HTTP, a server generally transmits a response to a request from a client. The response may comprise one or more data objects. For example, the response may comprise a first data object, followed by subsequently transmitted data objects. In particular embodiments, a client request may cause a server to respond with a first data object, such as an HTML page, which itself refers to other data objects. A client application, such as a browser, will request these additional data objects as it parses or otherwise processes the first data object.

In particular embodiments, the modification file 627 can include a set of game state parameters that characterize the state of various in-game objects, such as, for example, game state, player character state parameters, non-player character parameters, and virtual item parameters. In particular embodiments, game state is maintained in a database as a serialized, unstructured string of text data as a so-called binary large object (BLOB). When a player 101 accesses an online game on game networking system 120b, the BLOB containing the game state for the instance corresponding to the player 101 can be transmitted to client system 130 for use by a client-side executed object to process. In particular embodiments, the client-side executable may be a FLASH-based game, which can de-serialize the game state data in the BLOB. As a player 101 plays the game, the game logic implemented at client system 130 maintains and modifies the various game state parameters locally. The client-side game logic may also batch game events, such as mouse clicks, and transmit these events to game networking system 120b. Game networking system 120b may itself operate by retrieving a copy of the BLOB from a database or an intermediate memory cache (memcache) layer. Game networking system 120b can also de-serialize the BLOB to resolve the game state parameters and execute its own game logic based on the events in the batch file of events transmitted by the client to synchronize the game state on the server side. Game networking system 120b may then re-serialize the game state, now modified, into a BLOB and pass this to a memory cache layer for lazy updates to a persistent database.

With a client-server environment in which the online games may run, one server system, such as game networking system 120b, may support multiple client systems 130. At any given time, there may be multiple players 101 at multiple client systems 130 all playing the same online game. In practice, the number of players 101 playing the same game at the same time may be very large. As the game progresses with each player 101, multiple players 101 may provide different inputs to the online game at their respective client systems 130, and multiple client systems 130 may transmit multiple player inputs and/or game events to game networking system 120b for further processing. In addition, multiple client systems 130 may transmit other types of application data to game networking system 120b.

Application event data of a game is any data relevant to the game (e.g., player inputs). In particular embodiments, each application datum may have a name and a value, and the value of the application datum may change (i.e., be updated) at any time. When an update to an application datum occurs at client system 130, either caused by an action of a game player 101 or by the game logic itself, client system 130 may need to inform game networking system 120b of the update. For example, if the game is a farming game with a harvest mechanic (such as Zynga FarmVille), an event can correspond to a player 101 clicking on a parcel of land to harvest a crop. In such an instance, the application event data may identify an event or action (e.g., harvest) and an object in the game to which the event or action applies. For illustration purposes and not by way of limitation, system 600 is discussed in reference to updating a multi-player online game hosted on a network-addressable system (such as, for example, tool chain module 201 or game networking system 120b), where an instance of the online game is executed remotely on a client system 130, which then transmits application event data to the hosting system such that the remote game networking system 120b synchronizes game state associated with the instance executed by the client system 130.

In particular embodiment, one or more objects of a game may be represented as an Adobe Flash object. To ensure synchronization between the Flash object shown to the player 101 at client system 130, the Flash client may send the events that caused the game state changes to the in-game object to game networking system 120b. However, to expedite the processing and hence the speed of the overall gaming experience, the collaboration module 240 may collect a batch of some number of events or updates into a batch file. The number of events or updates may be determined by the Flash client dynamically or determined by game networking system 120b based on server loads or other factors. For example, client system 130 may send a batch file to game networking system 120b whenever 50 updates have been collected or after a threshold period of time, such as every minute.

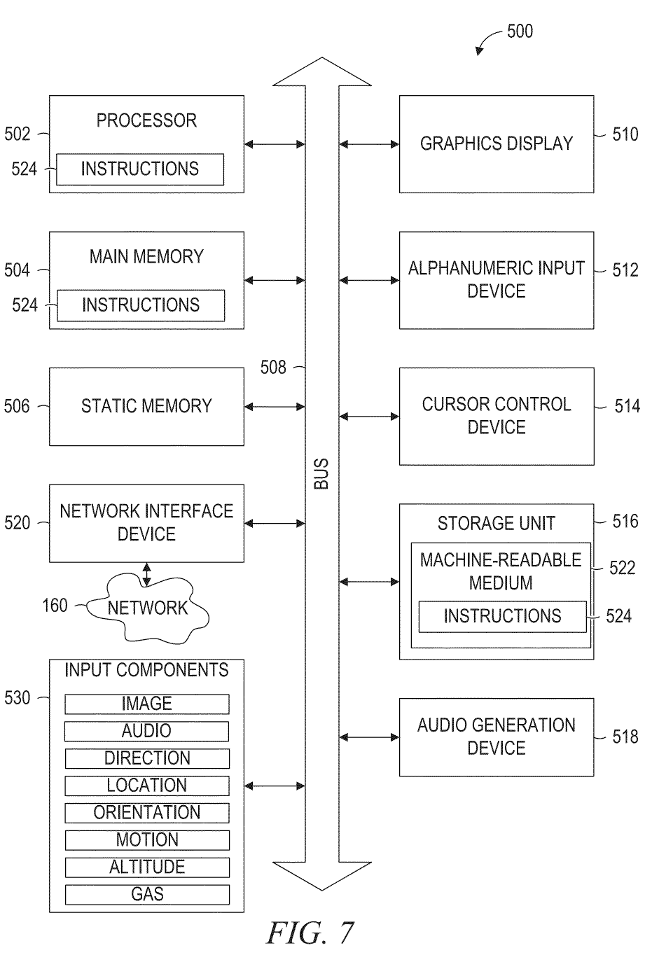

FIG. 7 is a block diagram illustrating components of a machine 700 (e.g., client system 130, social network system 120a, game networking system 120b, tool chain module 201), according to some example embodiments. The machine 700 is able to read instructions 724 from a machine-readable medium 722 (e.g., a non-transitory machine-readable medium, a machine-readable storage medium, a computer-readable storage medium, or any suitable combination thereof) and perform any one or more of the methodologies discussed herein, in whole or in part. Specifically, FIG. 7 shows the machine 700 in the example form of a computer system (e.g., a computer) within which the instructions 724 (e.g., software, a program, an application, an applet, an app, or other executable code) for causing the machine 700 to perform any one or more of the methodologies discussed herein may be executed, in whole or in part.

In alternative embodiments, the machine 700 operates as a standalone device or may be connected (e.g., networked) to other machines. In a networked deployment, the machine 700 may operate in the capacity of a server machine or a client machine in a server-client network environment, or as a peer machine in a distributed (e.g., peer-to-peer) network environment. The machine 700 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 724, sequentially or otherwise, that specify actions to be taken by that machine. Further, while only a single machine 700 is illustrated, the term “machine” shall also be taken to include any collection of machines 700 that individually or jointly execute the instructions 724 to perform all or part of any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724, such that the processor 702 is configurable to perform any one or more of the methodologies described herein, in whole or in part. For example, a set of one or more microcircuits of the processor 702 may be configurable to execute one or more modules (e.g., software modules) described herein.

The machine 700 may further include a graphics display 710 (e.g., a plasma display panel (PDP), a light emitting diode (LED) display, a liquid crystal display (LCD), a projector, a cathode ray tube (CRT), or any other display capable of displaying graphics or video). The machine 700 may also include an alphanumeric input device 712 (e.g., a keyboard or keypad), a cursor control device 714 (e.g., a mouse, a touchpad, a trackball, a joystick, a motion sensor, an eye tracking device, or another pointing instrument), a storage unit 716, an audio generation device 718 (e.g., a sound card, an amplifier, a speaker, a headphone jack, or any suitable combination thereof), and a network interface device 720.

The storage unit 716 includes the machine-readable medium 722 (e.g., a tangible and non-transitory machine-readable storage medium) on which are stored the instructions 724 embodying any one or more of the methodologies or functions described herein. The instructions 724 may also reside, completely or at least partially, within the main memory 704, within the processor 702 (e.g., within the processor's cache memory), or both, before or during execution thereof by the machine 700. Accordingly, the main memory 704 and the processor 702 may be considered machine-readable media 722 (e.g., tangible and non-transitory machine-readable media). The instructions 724 may be transmitted or received over the network 160 via the network interface device 720. For example, the network interface device 720 may communicate the instructions 724 using any one or more transfer protocols (e.g., Hypertext Transfer Protocol (HTTP)).

In some example embodiments, the machine 700 may be a portable computing device, such as a smartphone or tablet computer, and may have one or more additional input components 730 (e.g., sensors or gauges). Examples of such input components 730 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components 730 may be accessible and available for use by any of the modules described herein.

As used herein, the term “memory” refers to a machine-readable medium 722 able to store data temporarily or permanently and may be taken to include, but not be limited to, random-access memory (RAM), read-only memory (ROM), buffer memory, flash memory, and cache memory. While the machine-readable medium 722 is shown in an example embodiment to be a single medium, the term “machine-readable medium” should be taken to include a single medium or multiple media (e.g., a centralized or distributed database, or associated caches and servers) able to store instructions 724. The term “machine-readable medium” shall also be taken to include any medium, or combination of multiple media, that is capable of storing the instructions 724 for execution by the machine 700, such that the instructions 724, when executed by one or more processors of the machine 700 (e.g., processor 702), cause the machine 700 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 722 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors 702) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor 702. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor 702 configured by software to become a special-purpose processor, the general-purpose processor 702 may be configured as respectively different special-purpose processors (e.g., comprising different hardware modules) at different times. Software (e.g., a software module) may accordingly configure one or more processors 702, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 708) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 702 that are temporarily configured (e.g., by software) or permanently configured to perform the relevant operations. Whether temporarily or permanently configured, such processors 702 may constitute processor-implemented modules that operate to perform one or more operations or functions described herein. As used herein, “processor-implemented module” refers to a hardware module implemented using one or more processors 702.

Similarly, the methods described herein may be at least partially processor-implemented, a processor 702 being an example of hardware. For example, at least some of the operations of a method may be performed by one or more processors 702 or processor-implemented modules. As used herein, “processor-implemented module” refers to a hardware module in which the hardware includes one or more processors 702. Moreover, the one or more processors 702 may also operate to support performance of the relevant operations in a “cloud computing” environment or as a “software as a service” (SaaS). For example, at least some of the operations may be performed by a group of computers (as examples of machines 700 including processors 702), with these operations being accessible via a network 160 (e.g., the Internet) and via one or more appropriate interfaces (e.g., an application programming interface (API)).

The performance of certain operations may be distributed among the one or more processors 702, not only residing within a single machine 700, but deployed across a number of machines 700. In some example embodiments, the one or more processors 702 or processor-implemented modules may be located in a single geographic location (e.g., within a home environment, an office environment, or a server farm). In other example embodiments, the one or more processors 702 or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine 700. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine 700 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A computer-implemented method, comprising:
receiving, from a first development tool, a first modification code defining a first game modification of a game application on a client device of a user, the first modification code having a first format;
receiving, from a second development tool, a second modification code defining a second game modification of the game application, the second modification code having a second format being different from the first format;
in an automated operation using one or more computer processors configured to perform the automated operation, generating a composite modification file based on the first modification code and the second modification code, the composite modification file defining the first game modification and the second game modification in a common format; and
transmitting the composite modification file to the client device, to enable updating, without a user request from an application store, of the game application on the client device by use of the composite modification file.

2. The method of claim 1, wherein the composite modification file includes text representations of attributes associated with the first game modification and the second game modification.

3. The method of claim 2, wherein the composite modification file is configured for execution by the client device to modify an existing code of the game application by incorporating the attributes to the existing code.

4. The method of claim 2, wherein the attributes include art asset parameters, animation parameters, game play parameters, player character state, or game level settings.

5. The method of claim 2, wherein the second game modification modifies an attribute that has been modified by the first game modification.

6. The method of claim 5, wherein the first modification code is received from a first game developer, and wherein the second modification code is received from a second game developer.

7. The method of claim 6, further comprising:
resolving a conflict, using a collaboration module having a state machine, between the first modification code and the second modification code by only including, in the composite modification file, the attributes that have a current version based on the state machine.

8. The method of claim 1, further comprising:
generating a software extension for the game application on the client device, the software extension permitting a remote update by a game networking system, wherein the remote update is based on the composite modification file.

9. The method of claim 1, further comprising:
presenting a single user interface, the single user interface having features associated with the first development tool and the second development tool.

10. The method of claim 9, wherein the first development tool is a graphics editor, and the second development tool is animation software.

11. The method of claim 1, further comprising:
receiving a third modification code from a third development tool, the third modification code having a different format than the first modification code and the second modification code, and wherein the composite modification file includes the third modification code.

12. The method of claim 1, wherein the composite modification file is not converted to binary code, and wherein the updating does not include uploading the composite modification file into the application store.

13. The method of claim 1, wherein the composite modification file is platform agnostic, and wherein the composite modification file does not include distribution code.

14. The method of claim 1, wherein the user request is a request to download a current version of the game application from an application store.

15. The method of claim 1, wherein the composite modification file is a single text file.

16. A system comprising:
a transceiver configured to:
receive, from a first development tool, a first modification code defining a first game modification of a game application on a client device of a user, the first modification code having a first format; and
receive, from a second development tool, a second modification code defining a second game modification of the game application, the second modification code having a second format being different from the first format; and
one or more computer processors configured by a tool chain module to:
generate a composite modification file based on the first modification code and the second modification code, the composite modification file defining the first game modification and the second game modification in a common format; and
transmit the composite modification file to the client device, to enable updating, without a user request from an application store, of the game application on the client device by use of the composite modification file.

17. The system of claim 16, wherein the composite modification file includes text representations of attributes associated with the first game modification and the second game modification.

18. The system of claim 17, wherein the composite modification file is configured for execution by the client device to modify an existing code of the game application by incorporating the attributes to the existing code.

19. The system of claim 16, further comprising:
a single user interface configured to present features associated with the first development tool and the second development tool.

20. A non-transitory machine-readable storage medium comprising instructions that, when executed by one or more processors of a machine, cause the machine to perform operations comprising:
receiving, from a first development tool, a first modification code defining a first game modification of a game application on a client device of a user, the first modification code having a first format;
receiving, from a second development tool, a second modification code defining a second game modification of the game application, the second modification code having a second format being different from the first format;
generating a composite modification file based on the first modification code and the second modification code, the composite modification file defining the first game modification and the second game modification in a common format; and
transmitting the composite modification file to the client device, to enable updating, without a user request from an application store, of the game application on the client device by use of the composite modification file.
